(19) United States
(12) Patent Application Publication
(10) Pub. No.: US 2025/0065546 A1
(43) Pub. Date: Feb. 27, 2025

(54) PLASTIC PRODUCT AND METHOD FOR PRODUCING A PLASTIC PRODUCT

(71) Applicant: Ritter GmbH, Schwabmünchen (DE)

(72) Inventors: Roman PREUß, Friedberg (DE); Samuel KREBBER, Königsbrunn (DE); Frank FINIS, Augsburg (DE); Frank NOVAK, Bobingen (DE)

(21) Appl. No.: 18/810,864

(22) Filed: Aug. 21, 2024

(30) Foreign Application Priority Data
Aug. 21, 2023 (DE) 102023122330.5

(51) Int. Cl. B29C 45/00; B29K 105/26; B29L 31/00

(52) U.S. Cl. CPC B29C 45/0001; B29C 2795/007; B29K 2105/26; B29L 2031/715; B29L 2031/7678

(57) ABSTRACT

A plastic product, for example a cartridge, is made of plastic material which has a ratio of at least 30 wt.-% of PCR (Post Consumer Recycled) material. A method for producing a plastic product using an injection molding process includes the following steps: (a) providing a partially recycled plastic material comprising a ratio of at least 30 wt.-% of PCR material; (b) liquefying the plastic material; (c) injecting the liquid plastic material into a cavity of a mold; and (d) demolding the product after cooling.

### FIELD

This disclosure relates to systems and methods for plastic products, such as cartridges. More specifically, the disclosed embodiments relate to injection molded plastic products.

### INTRODUCTION

Plastic products are widely used because they are light, cheap to manufacture, robust and therefore practical. Plastic products and plastic packaging are indispensable in various applications, including the storage of chemicals for constructional purposes, such as silicone, acrylic, etc. However, the more plastic containers and packages are used, the greater are the challenges in terms of sustainability. The use of recyclate, such as PCR (Post Consumer Recycled) or PIR (Post Industrial Recycled) material, reduces the problem of a lack of sustainability.

However, recyclates are unsuitable or difficult to handle for many applications. For example, the material properties are not defined due to different types and degrees of contamination in different batches of recyclate. These undefined properties can affect the geometry, e.g. the shrinkage dimensions. In addition, impurities may interact with the filler material of a cartridge as well as with imprints or coatings applied to the outside of the cartridge and impair their effectiveness.

To date, it has not been possible to reliably manufacture plastic cartridges from materials with high proportions of recycled material.

### SUMMARY

The present disclosure provides systems, apparatuses, and methods relating to plastic products.

In some examples, an injection molding method for producing a plastic product (e.g., comprising a ratio of at least 30 wt.-% of PCR (Post Consumer Recycled) material) may include: (a) providing a partially recycled plastic material comprising a ratio of at least 30 wt.-% of PCR material; (b) liquefying the plastic material; (c) injecting the liquid plastic material into a cavity of a mold; and (d) demolding the product after cooling.

Features, functions, and advantages may be achieved independently in various embodiments of the present disclosure, or may be combined in yet other embodiments, further details of which can be seen with reference to the following description and drawings.

### DETAILED DESCRIPTION

In general, the present disclosure describes methods of manufacturing a sustainable plastic product in a recycling process without considerably impairing the product quality. Previously known products and methods do not use PCR material, as it is difficult a) to produce cartridges using PCR material, and b) to print, especially clearly, on PCR material.

The present disclosure relates to a plastic product, for example a cartridge, comprising a ratio of at least 30 wt.-%, in particular at least 50 wt-%, in particular at least 60 wt.-%, in particular at least 70 wt-%, in particular at least 80 wt.-%, in particular at least 90 wt.-%, in particular 100 wt.-%, of recycled material, in particular of PCR (Post Consumer Recycled) material.

PCR (Post Consumer Recycled) material is mainly obtained from waste of food packaging, for example PET bottles. PCR (Post Consumer Recycled) material usually contains at least 3-5% wt.-% of residual substances and impurities, respectively. PCR is therefore a plastic that is made from consumer waste. These recycled plastics are referred to as rPET (Recycled Polyethylene Terephthalate), rPP (Recycled Polypropylene Plastic), rHDPE (Recycled High-Density Polythene), etc.

PIR (Post Industrial Recycled) is industrial plastic waste that is generated during production.

The plastic product may be, for example, a cartridge for receiving filling material. For example, such cartridges may include component cartridges used with sealants (e.g., silicone and acrylics) or adhesives, grease cartridges for containing lubricants, industrial dosing cartridges or syringes, ink cartridges for offset printing, and/or the like. However, the invention is not limited to these applications, but may be used in any other suitable application.

The plastic product may have a wall which has an outer side and an inner side, whereby a printing field is arranged on the outer side, which is printed directly by means of digital printing.

Printed images produced by means of direct digital printing on (partially) recycled material with a high ratio of recyclate, as in the present invention, could previously not be produced in high quality with a long service life. In particular, if the recyclate is not white but grey or black, color-fast digital printing is not possible; instead, in the prior art a label was used in such situations. However, the applicant has succeeded in digitally printing plastic products made of recyclate material directly. For example, first a white background is printed and the actual printed image is printed on top of the white background. In particular, rotationally symmetrical digital printing, e.g. on the outside of a cartridge, has successfully been carried out as part of the invention.

Recycled material is generally not clear, i.e. it is (at least partially or gradually) opaque, e.g. black, grey, green, etc., whereas producing white-colored cartridges is practically impossible. For brilliant, good color printing, however, a bright, white background is desirable. Therefore, according to the present disclosure, a white background is printed as the first color layer. As a design variant, the white color printing could also act as a barrier layer or adhesion promoter, in case the material composition of the color layer was suitable.

A method according to the invention for manufacturing a plastic product, in particular a plastic product as described above, by using an injection molding process comprises the following steps:
(a) providing an at least partially recycled plastic material comprising a ratio of at least 30 wt.-%, in particular at least 50 wt-%, in particular at least 60 wt.-%, in particular at least 70 wt-%, in particular at least 80 wt.-%, in particular at least 90 wt.-%, in particular 100 wt.-%, of PCR (Post Consumer Recycled) material;
(b) liquefying the plastic material;
(c) injecting the liquid plastic into a cavity of a mold; and
(d) demolding the product after cooling.

The injection molding equipment may have a mold and a core, both of them delimiting the cavity, and the core may be pulled out of the interior of the plastic product after step (c) and before step (d).

An alternative method for producing at least a component of a plastic product, in particular a plastic product as described above, comprises the following steps:
(a) provision of (partially) recycled plastic material comprising a ratio of at least 30 wt-%-100 wt-% of PCR material,
(b) continuous liquefaction of plastic material,
(c) extruding the plastic material to produce the plastic product or the component of the plastic product.

The ratio of 30%-100% means that any value between and including 30% and 100% may be set as a minimum threshold value of the ratio, particularly any of the threshold values mentioned above (30 wt.-%, 50 wt-%, 60 wt.-%, 70 wt-%, 80 wt.-%, 90 wt.-%, 100 wt.-%).

A further step in any of the above-mentioned methods may be:
(e) direct printing of a printing field of the plastic product by means of digital printing process.

A plastic product as described and/or manufactured above has an outer contour corresponding (or complementary) to an inner contour of a mold, and an inner contour corresponding (or complementary) to an outer contour of a core, wherein the inner contour has a demolding bevel of 0.1° to 15°, in particular of 0.1° to 10°, in particular of 0.1° to 5°, in particular of 0.1° to 1°, in particular of 0.1° to 0.5°.

The printing field may be pre-treated, in particular the printing field may be pre-printed in white. Afterwards, direct printing by means of digital printing on the printing field is conducted, e.g. in a laser or inkjet printing process.

Particularly, but not limited, the plastic product may be a wall and the cylindrical outer wall portion, respectively, of a cartridge (or chamber of a cartridge).

Plastic products according to the invention significantly reduce the product-related CO₂ footprint.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A plastic product, made of plastic material comprising a ratio of at least 30 wt.-% of PCR (Post Consumer Recycled) material.

2. The plastic product according to claim 1, wherein said plastic material comprises a ratio of at least 50 wt.-% of PCR (Post Consumer Recycled) material.

3. The plastic product according to claim 1, wherein said plastic material comprises a ratio of at least 60 wt.-% of PCR (Post Consumer Recycled) material.

4. The plastic product according to claim 1, wherein said plastic material comprises a ratio of at least 70 wt.-% of PCR (Post Consumer Recycled) material.

5. The plastic product according to claim 1, wherein said plastic material comprises a ratio of at least 80 wt.-% of PCR (Post Consumer Recycled) material.

6. The plastic product according to claim 1, wherein said plastic material comprises a ratio of at least 90 wt.-% of PCR (Post Consumer Recycled) material.

7. The plastic product according to claim 1, wherein said plastic material 100 wt.-% of PCR (Post Consumer Recycled) material.

8. The plastic product according to claim 1, wherein the PCR (Post Consumer Recycled) material contains a ratio of foreign substance and impurities, respectively, of at least 3-5 wt.-%.

9. The plastic product according to claim 1, wherein the plastic product is a receptacle of a cartridge for receiving filling material.

10. The plastic product according to claim 1, wherein the plastic product has an outer side, wherein a printing field is arranged on the outer side, the printing field being printed directly by means of a digital printing process.

11. A method for producing the plastic product according to claim 1, using an injection molding process, the method comprising:
(a) providing a partially recycled plastic material comprising a ratio of at least 30 wt.-% of PCR material;
(b) liquefying the plastic material;
(c) injecting the liquid plastic material into a cavity of a mold; and
(d) demolding the product after cooling.

12. The method according to claim 11, wherein the mold comprises an outer mold and a core which delimit the cavity, and the core is pulled out of the interior of the plastic product after step (c) and before step (d).

13. A method for producing at least a component of the plastic product according to claim 1, the method comprising:
(a) providing recycled plastic material comprising a ratio of at least 30 wt-% to 100 wt-% of PCR material,
(b) conducting continuous liquefaction of the plastic material,
(c) extruding the plastic material to produce the plastic product or the component of the plastic product.

14. The method according to claim 11, further comprising:
(e) direct printing on a printing field of the plastic product using a digital printing process.

15. The method of claim 11, wherein the plastic product comprises an outer contour corresponding to an inner contour of an outer mold and an inner contour corresponding to an outer contour of a core, wherein the inner contour has a demolding bevel of 0.1° to 45°.
